(19) United States
(12) Patent Application Publication
(10) Pub. No.: US 2014/0217843 A1
(43) Pub. Date: Aug. 7, 2014

(54) MOTOR HAVING COOLING STRUCTURE

(71) Applicant: Hyundai Motor Company, Seoul (KR)

(72) Inventors: Jae Hyuk SUH, Yongin-si (KR); Hyun KIM, Uiwang-si (KR); Sam Gyun KIM, Hwaseong-si (KR); Seung Woo HA, Suwon-si (KR)

(73) Assignee: HYUNDAI MOTOR COMPANY

(21) Appl. No.: 13/945,522

(22) Filed: Jul. 18, 2013

(30) Foreign Application Priority Data
Feb. 6, 2013 (KR) 10-2013-0013417

(51) Int. Cl. H02K 9/00

(52) U.S. Cl. CPC H02K 9/005
USPC 310/57

(57) ABSTRACT

A motor having a cooling structure includes a rotor fixed to a rotatable motor shaft, a rotor coil formed adjacent the rotor, a coil protection cover disposed adjacent the rotor coil, mounted in the motor shaft, and having a coolant chamber filled with a coolant. The motor further includes a stator fixed adjacent an exterior circumference of the rotor and may include a cover in which one end portion of the motor shaft is rotatably penetrated having a cooling pin at an internal side surface opposite one side surface of the coil protection cover. The coolant filled in the coolant chamber of the coil protection cover receives heat generated in the rotor coil, and, by effectively emitting the heat to the outside through the cooling pin formed in a rear cover, durability of the entire motor can be improved, and failure of peripheral parts can be prevented.

### CROSS-REFERENCE TO RELATED APPLICATION

This application claims priority to and the benefit of Korean Patent Application No. 10-2013-0013417 filed in the Korean Intellectual Property Office on Feb. 6, 2013, the entire contents of which are incorporated herein by reference.

### TECHNICAL FIELD

The present disclosure relates to a motor that generates a torque through a rotor rotating together with a motor shaft and a stator fixed to a motor housing, particularly to a motor with a cooling structure that effectively cools elements.

### BACKGROUND

In a hybrid vehicle or some electric vehicle, a permanent magnet, or interior permanent magnet synchronous motor (IPMSM) is used, which is easily controlled and produced in a small size. However, when a motor uses such a permanent magnet, the price thereof may be increased.

Therefore, a non-rare earth motor that does not use an IPMSP or a permanent magnet has been developed. Such a non-rare earth motor includes a field coil motor, known as a wound rotor synchronous motor (WRSM).

Such a field coil motor is able to supply a current to the rotor by winding a rotor coil without help of a permanent magnet in a rotor, unlike the IPMSP, thereby magnetizing the rotor. Such a field coil motor has a structure where a brush and a slip ring are mounted in a motor shaft and the rotor is rotated by supplying a direct current (DC) current.

The field coil motor may have a volume larger than that of a permanent magnet motor but may still obtain the same performance. Further, the field coil motor has the same volume as that of the permanent magnet motor by developed technology.

However, when the field coil motor operates, temperature of the rotor coil that is wound in the rotor may increase to about 200° or more, and the structure that cools the stator generally has difficulty in cooling the rotor. Therefore, life-span of the entire motor decreases, and peripheral parts may fail.

The above information disclosed in this background section is only for enhancement of understanding of the background of the present disclosure and therefore it may contain information that does not form the prior art that is already known in this country to a person of ordinary skill in the art.

### SUMMARY

The present disclosure has been made in an effort to provide a motor having a cooling structure with advantages of improving durability of the entire motor and preventing a failure of peripheral parts by protecting a rotor coil and effectively emitting heat generated in the rotor coil to the outside.

A motor having a cooling structure includes: a rotor that is fixed to a rotatable motor shaft; a rotor coil that is formed adjacent the rotor; a coil protection cover that is disposed adjacent the rotor coil, is mounted in the motor shaft, and has a coolant chamber filled with a coolant therein; and a stator that is fixed adjacent an exterior circumference of the rotor.

The motor may further include a cover in which one end portion of the motor shaft is rotatably penetrated and has a cooling pin at an internal side surface opposite to one side surface of the coil protection cover.

The cover may be a rear cover disposed at the rear side of the motor shaft.

In a central part of the coil protection cover, a shaft hole in which the motor shaft penetrates may be formed, and the coolant chamber may be formed in a rotating direction of the motor shaft at the inside of the coil protection cover.

The cooling pin may be formed in a rotating direction of the coil protection cover rotating together with the motor shaft.

An end portion of the cooling pin may be extended adjacent one side of the coil protection cover.

A heat emission hole for emitting the heat, that is transferred from the coil protection cover through the cooling pin to the outside, may be opened from the inside of the rear cover to the outside.

Another embodiment of the present disclosure provides a motor having a cooling structure including: a rotor that is fixed to a rotatable motor shaft; a coil protection cover that is disposed adjacent the rotor coil, mounted in the motor shaft, and has a coolant chamber filled with a coolant therein; and a stator that is fixed adjacent an exterior circumference of the rotor.

The motor may further include a cover in which one end portion of the motor shaft is rotatably penetrated, which has a cooling pin at an internal side surface opposite to one side surface of the coil protection cover.

As described above, in a motor having a cooling structure according to an exemplary embodiment of the present disclosure, a coolant that is filled in a coolant chamber of a coil protection cover effectively receives heat generated in a rotor coil, and by effectively emitting thermal energy to the outside through a cooling pin that is formed in a rear cover, durability of the entire motor can be improved and a failure of peripheral parts can be prevented.

### BRIEF DESCRIPTION OF THE DRAWINGS

FIG. 1 is a partial cross-sectional view of a motor having a cooling structure according to an exemplary embodiment of the present disclosure.

FIG. 2 is a perspective view and a partially cut perspective view of a coil protection cover that is provided in a motor having a cooling structure according to an exemplary embodiment of the present disclosure.

FIG. 3 is a perspective view illustrating the inside of a rear cover that is provided in a motor having a cooling structure according to an exemplary embodiment of the present disclosure.

FIG. 4 is a partially perspective view illustrating the read side of a motor having a cooling structure according to an exemplary embodiment of the present disclosure.

### DETAILED DESCRIPTION

An exemplary embodiment of the present disclosure will hereinafter be described in detail with reference to the accompanying drawings.

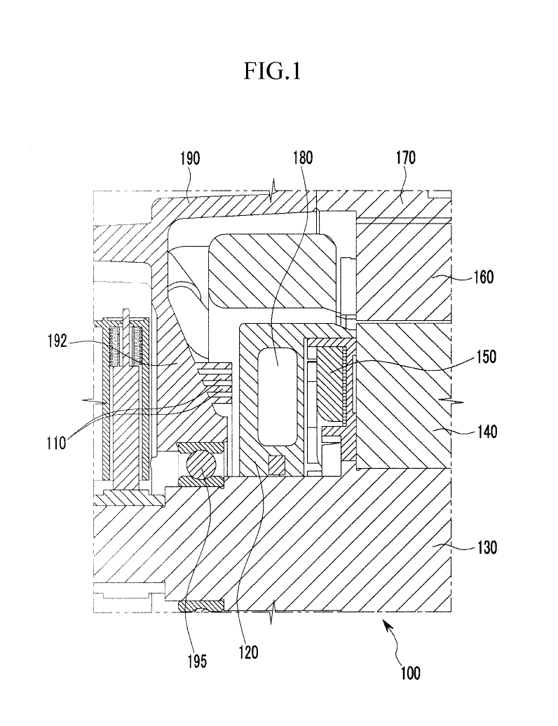

FIG. 1 is a partial cross-sectional view of a motor having a cooling structure according to an exemplary embodiment of the present disclosure.

Referring to FIG. 1, a motor 100 includes a motor shaft 130, a rotor 140, a rotor coil 150, a stator 160, a motor housing 170, a rear cover 190, a bearing 195, and a coil protection cover 120.

The rotor 140 is fixed to an exterior circumference of one side of the motor shaft 130, and the rotor coil 150 is disposed adjacent the rear side of the rotor 140. In order to protect the rotor coil 150 from the outside, the coil protection cover 120 is mounted to the motor shaft 130.

The coil protection cover 120 rotates together with the motor shaft 130 and protects the rotor coil 150. Further, a coolant chamber 180 is formed at the inside of the coil protection cover 120, and a coolant is filled in the coolant chamber 180.

The coolant filled in the coolant chamber 180 absorbs heat that is generated in the rotor coil 150 through the coil protection cover 120 and emits the absorbed heat to the outside through the rear cover 190.

In the rear cover 190, a cooling pin 110 is formed at an inner surface opposite the coil protection cover 120. An end portion of the cooling pin 110 is extended adjacent one side surface of the coil protection cover 120.

A rear end portion of the motor shaft 130 penetrates a central portion of the rear cover 190, the bearing 195 is disposed between an exterior circumference of the motor shaft 130 and the rear cover 190, and the motor shaft 130 rotates through the bearing 195.

The cooling pin 110 that is formed at an inner surface of the rear cover 190 receives the heat from the coil protection cover 120, and the received heat is emitted to the outside through a wall 192 of the rear cover 190.

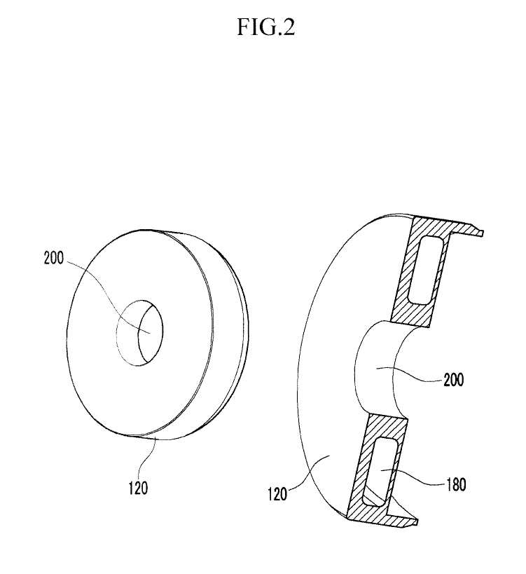

FIG. 2 is a perspective view and a partially cut perspective view of the coil protection cover that is provided in a motor having a cooling structure according to an exemplary embodiment of the present disclosure.

Referring to FIG. 2, a shaft hole 200 is formed in a central portion of the coil protection cover 120, and the motor shaft 130 penetrates the shaft hole 200, and the motor shaft 130 and the coil protection cover 120 rotate together. At the inside of the coil protection cover 120, the coolant chamber 180 is formed in a circumference direction, and the coolant is filled in the coolant chamber 180.

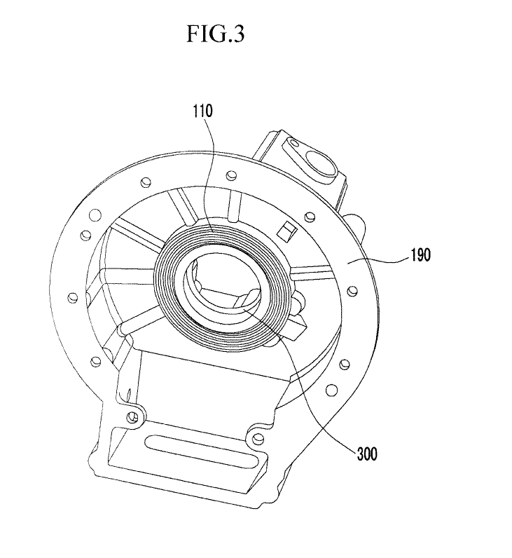

FIG. 3 is a perspective view illustrating the inside of the rear cover provided in a motor having a cooling structure according to an exemplary embodiment of the present disclosure.

Referring to FIG. 3, in the rear cover 190, the cooling pin 110 is formed at an inner surface opposite to the coil protection cover 120, and the cooling pin 110 is formed in a circumference direction along a hole in which the motor shaft 130 penetrates. Further, in the rear cover 190, a bearing mounting portion 300 is formed along an interior circumference of the hole in which the motor shaft 130 penetrates.

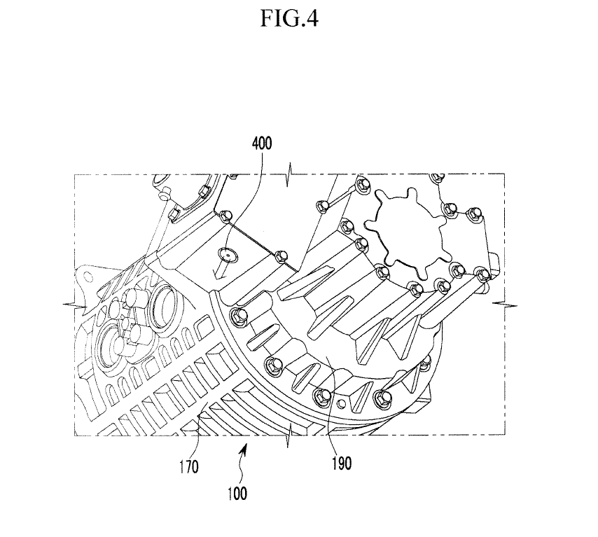

FIG. 4 is a partially cut perspective view illustrating the read side of a motor having a cooling structure according to an exemplary embodiment of the present disclosure.

Referring to FIG. 4, the motor includes a motor housing 170 and a rear cover 190, and a heat emission hole 400 is formed at one side of the rear cover 190. A heat of the inside of the motor 100 is emitted to the outside through the heat emission hole 400.

Referring to FIGS. 1 to 4, heat that is generated in the rotor 140 or the rotor coil 150 is stored in the coolant chamber 180 filled with coolant through the coil protection cover 120 or is emitted to the outside. Heat energy that is transferred from the coil protection cover 120 is emitted to the outside through the rear cover 190 or the cooling pin 110.

In an exemplary embodiment of the present disclosure, when the motor shaft 130 rotates together with the rotor 140 and the coil protection cover 120, and the coolant filled in the coolant chamber 180 that is formed at the inside of the coil protection cover 120 also rotates. The coolant absorbs thermal energy while flowing inside the coolant chamber 180 without controlling from the outside.

In order to effectively receive the heat from the coolant flowing inside of the coil protection cover 120, the cooling pin 110 is formed in the rear cover 190, and thermal energy from the heat transferred to the rear cover 190 through the cooling pin 110 is effectively emitted to the outside through a pressure adjustment hole (heat emission hole 400) of a terminal block.

A coolant filled in the coil protection cover 120 is the same coolant as the coolant flown and thus a separate cooling medium is unnecessary, and a fan and a radiator as separate cooling modules are not added thus reducing cost. The motor has a simple structure, and the coolant can cool the stator and the inside of the motor. Further, the motor according to an exemplary embodiment of the present disclosure can be applied to a field coil motor and a general permanent magnet motor.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

What is claimed is:

1. A motor having a cooling structure, comprising:
a rotor that is fixed to a rotatable motor shaft;
a rotor coil adjacent the rotor;
a coil protection cover that is disposed adjacent the rotor coil, mounted in the motor shaft, and having a coolant chamber is filled with a coolant; and
a stator fixed adjacent an exterior circumference of the rotor.

2. The motor of claim 1, further comprising a cover in which one end portion of the motor shaft is rotatably penetrated and has a cooling pin disposed at an internal side surface opposite to one side surface of the coil protection cover.

3. The motor of claim 2, wherein the cover is a rear cover disposed at the rear side of the motor shaft.

4. The motor of claim 2, wherein, in a central part of the coil protection cover, a shaft hole in which the motor shaft penetrates is formed, and
the coolant chamber is formed in a rotating direction of the motor shaft at the inside of the coil protection cover.

5. The motor of claim 2, wherein the cooling pin is formed in a rotating direction of the coil protection cover rotating together with the motor shaft.

6. The motor of claim 2, wherein an end portion of the cooling pin is extended adjacent one side surface of the coil protection cover.

7. The motor of claim 2, wherein a heat emission hole for emitting heat that is transferred from the coil protection cover through the cooling pin to the outside is opened from the inside of the rear cover to the outside.

8. A motor having a cooling structure, comprising:
a rotor fixed to a rotatable motor shaft;
a coil protection cover, that is disposed adjacent the rotor coil, mounted in the motor shaft, and having a coolant chamber filled with a coolant; and
a stator fixed adjacent an exterior circumference of the rotor.

9. The motor of claim 8, further comprising a cover in which one end portion of the motor shaft is rotatably penetrated and having a cooling pin at an internal side surface opposite one side surface of the coil protection cover.
